(19) United States
(12) Patent Application Publication
(10) Pub. No.: US 2007/0202480 A1
(43) Pub. Date: Aug. 30, 2007

(54) Digital karaoke jukebox

(76) Inventors: Brenda S. Steele, Hardy, VA (US); Randolph Steele, Hardy, VA (US)

Correspondence Address: David O. Simmons;Galasso & Associates LP, P.O. Box 26503, Austin, TX, 78755-0503, US

(21) Appl. No.: 11/525,423

(22) Filed: Sep. 22, 2006

Related U.S. Application Data
(60) Provisional application No. 60/777,477, filed on Feb. 28, 2006.

(51) Int. Cl. G09B 5/00

(52) U.S. Cl. 434/307 A

(57) ABSTRACT

A Karaoke machine comprises a plurality of digital media sources, a user interface, a microphone input interface and a machine session management unit. The user interface enables a user to select a Karaoke media file corresponding to a respective one of the Karaoke media files accessible by one of the digital media sources. The microphone input interface enables a voice signal to be received from a microphone. The machine session management unit is coupled to the digital media sources, the user interface and the microphone input interface. The machine session management unit facilitates receiving the selected Karaoke media file, accessing the respective one of the Karaoke media files, outputting a musical audio portion of the respective one of the Karaoke media files and outputting the voice signal in conjunction with the outputting the musical audio portion of the respective one of the Karaoke media file.

### CROSS REFERENCE TO RELATED APPLICATIONS

This patent application claims priority to co-pending United States Provisional Patent Application having Ser. No. 60/777,477 filed Feb. 28, 2006 entitled “Karaoke Jukebox”, having a common applicant herewith and being incorporated herein in its entirety by reference.

### FIELD OF THE DISCLOSURE

The disclosures made herein relate generally to Karaoke machines, system and methodologies and, more particularly, to machines, systems and methods for facilitating selection and presentation of music selections during a Karaoke session.

### BACKGROUND

Karaoke is a style of singing where a person, typically an amateur or non-professional singer, sings a song to a pre-recorded accompaniment of music. Typically, the music is accompanied by lyrics that are displayed on a video display screen. Quite often a singer will know a portion of the lyrics but not the lyrics in their entirety. Thus, the displayed lyrics serve the purpose of assisting the singer to sing the lyrics correctly.

Although Karaoke was first made popular in Japan, it has become popular throughout the world. Bars and restaurants that cater to Karaoke performers have become commonplace, offering songs and lyrics in many different languages. Performing in Karaoke sessions in front of an audience or in private offers numerous benefits to those that participate. Examples of such benefits include, but are not limited to, improving memory functionality by having to read and recall lyrics while singing, improving one's self-esteem and confidence and helps to take one's mind off of daily issues that cause stress.

It is common for an establishment offering Karaoke sessions to its patrons to hire a Disc Jockey (DJ) that takes song requests, calls singers in turn and plays requested music and/optionally, lyrics. DJ's add to the expense of offering Karaoke sessions and can often create problems when they are not able to show for a scheduled Karaoke session. Additionally, with respect to music genres, artists, and/or time periods, DJ's are often limited in the music selections that they have available to offer to Karaoke performers simply due to the expense, space and/or organization required for maintaining an overly large music collection with corresponding lyric video.

Therefore, a Karaoke system that eliminates the need for a DJ, that allows a Karaoke singer to conveniently facilitate playback of desired music selections and that offers an abundant, diverse and readily changable selection of music would be advantageous, desirable and useful.

### SUMMARY OF THE DISCLOSURE

Embodiments of the present invention provide a system and method for enabling a Karaoke session to be facilitated without the need for a disc jockey. More specifically, embodiments of the present invention provide for a Karaoke media system that allows a Karaoke performer to select a desired Karaoke media file, output a musical audio portion of a Karaoke media file corresponding to the desired Karaoke media file and output a voice signal (i.e., singing) of the Karaoke Performer in conjunction with outputting the musical audio portion of the Karaoke media file. The Karaoke media system also enables a lyrical text portion of the Karaoke media file to be synchronously outputted in conjunction with the musical audio portion of the Karaoke media file. Accordingly, embodiments of the present invention reduce cost associated with facilitating Karaoke events, reduce adverse human factors associated with providing music at Karaoke events, add convenience to facilitating Karaoke events and enable Karaoke events to be carried out in virtually any location.

In one embodiment of the present invention, a Karaoke machine comprises a plurality of digital media sources, a user interface, a microphone input interface and a machine session management unit. The digital media sources include a hard drive having Karaoke media files stored thereon, a MP3 player having memory with Karaoke media files stored thereon, a compact disc player including a collection of compacts discs each having Karaoke media files stored thereon, a patron-accessible compact disc drive and a patron-accessible Universal Serial Bus Interface. The user interface enables a user to select a Karaoke media file corresponding to a respective one of the Karaoke media files accessible by one of the digital media sources. The microphone input interface enables a voice signal to be received from a microphone. The machine session management unit is coupled to the digital media sources, the user interface and the microphone input interface. The machine session management unit facilitates receiving the selected Karaoke media file, accessing the respective one of the Karaoke media files, outputting a musical audio portion of the respective one of the Karaoke media files and outputting the voice signal in conjunction with the outputting the musical audio portion of the respective one of the Karaoke media file.

In another embodiment of the present invention, a Karaoke media system comprises a first digital media source, a microphone input interface, a video output interface, an audio output interface, a document printer interface, digital memory and one or more data processing devices. The first digital media source enables Karaoke media files to be accessed therefrom. The microphone input interface enables a voice signal to be received from a microphone. The video output interface enables a lyrical text portion of the Karaoke media files to be outputted to a remote video display apparatus. The audio output interface enables a musical audio portion of the Karaoke media files to be outputted to a remote audio output apparatus. The document printer interface enables Karaoke session information to be outputted in printed form. The digital memory has system operating instructions accessible therefrom. The one or more data processing devices are coupled to the digital memory for enabling the system operating instructions to be accessed and processed by the at least one data processing device. Processing of the system operating instructions facilitates the Karaoke media files being accessed from the first digital media source, the voice signal being received through the microphone input interface, the lyrical text portion of the Karaoke media files being outputted to the remote audio output apparatus through the video output interface, the musical audio portion of the Karaoke media files being outputted to the remote video display unit through the audio output interface and the Karaoke session information being outputted through the document printer interface to a printing device.

In another embodiment of the present invention, a method for facilitating a Karaoke session comprises a plurality of operations. An operation is performed for receiving a request for initiating a Karaoke session. The request is received by a data processing device of a Karaoke media system. An operation is performed for displaying Karaoke media files accessible from a digital media source of the Karaoke media system. An operation is performed for receiving a Karaoke media file selection corresponding to one of the available Karaoke media files. The Karaoke media file selection is received by the data processing module of the Karaoke media system. An operation is performed for accessing a Karaoke media file corresponding to the Karaoke media file selection. The operation of accessing is performed by the digital media source of the Karaoke media system. An operation is performed for outputting an audio portion of the Karaoke media file. The operation of outputting of the audio portion is facilitated through a speaker output interface of the Karaoke media system. An operation is performed for outputting a voice signal received at a microphone input interface of the Karaoke media system in conjunction with outputting the audio portion of the Karaoke media file. The operation of outputting the voice signal is facilitated through an audio output interface of the Karaoke media system.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows an embodiment of a Karaoke media system in accordance with the present invention.

FIG. 2 shows an embodiment of a method for facilitating Karaoke session functionality in accordance with the present invention.

FIG. 3 shows an embodiment of a Karaoke machine in accordance with the present invention.

### DETAILED DESCRIPTION OF THE DRAWING FIGURES

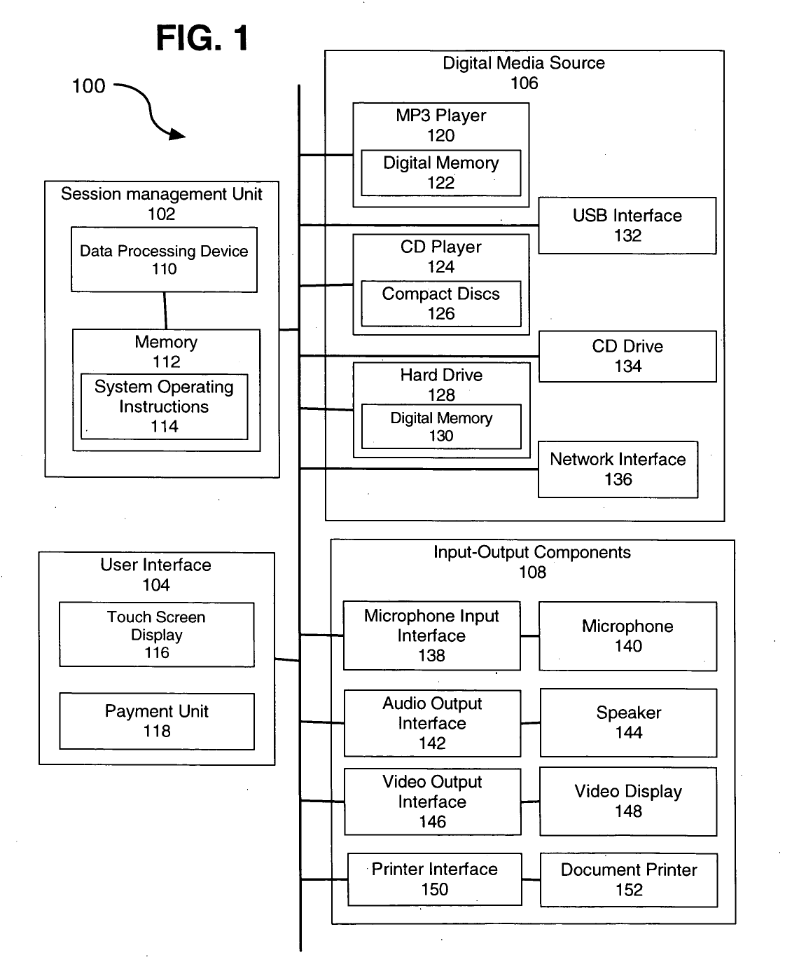

FIG. 1 depicts an embodiment of a Karaoke media system in accordance with the present invention, which is referred to herein as the Karaoke media system 100. The Karaoke media system 100 includes a session management unit 102, a user interface 104, digital media sources 106 and input-output components 108. The session management unit 102, the user interface 104, the digital media sources 106 and the input-output components 108 are interconnected for enabling interaction therebetween, thus providing for Karaoke session functionality in accordance with the present invention.

The session management unit 102 includes a data processing device 110 and digital memory 112. A random access memory module and/or a hard drive are examples of the digital memory 112. The digital memory 112 has system operating instructions 114 accessible therefrom. The data processing device is coupled to the digital memory for enabling the system operating instructions to be accessed and processed by the data processing device. It is disclosed herein that the session management unit 102 may include more than one data processing device, which share instruction processing responsibilities. As will be discussed below in greater detail, the system operating instructions control functionality of the session management unit 102, the user interface 104, the digital media sources 106 and the input-output components 108 for carrying out enabling Karaoke session functionality in accordance with the present invention.

The user interface 104 includes a touch screen display 116 and a payment unit 118. Visual information is viewable on the touch screen display 116 and touching a region of the screen corresponding to a respective input selection facilitates user input. To this end, the touch screen display 116 enables a Karaoke session performer to consider and act on information required for enabling the Karaoke media system to carry out Karaoke session functionality in accordance with the present invention. The payment unit 118 enables a Karaoke session performer to pay for one or more Karaoke sessions that will thereafter be supported by the Karaoke media system 100. Examples of the payment unit 118 include, but are not limited to, a dollar bill receiving unit, a credit card reader, a token receiving unit and the like. Various types and configurations of touch screen displays and payment units are well known and, in view of the disclosures made herein, a skilled person will contemplate various approaches for implementing a touch screen display and/or payment unit in embodiments of the present invention.

Karaoke media files are accessible via each one of the digital media sources 106. Karaoke media files refer to digital files that include a musical audio portion (i.e., a song) and, optionally, a corresponding lyrical text portion (i.e., lyrics to the song). A first one of the digital media sources 106 is a MP3 player 120 having digital memory 122 with Karaoke media files stored thereon. Each one of the Karaoke media files stored on the digital memory 122 of the MP3 player 120 is accessible by a playback portion of the MP3 player 120 for outputting respective contents of the Karaoke media files stored on the digital memory 122 of the MP3 player 120. A second one of the digital media sources 106 is a compact disc player 124 including a collection of compacts discs 126. Each one of the compact discs 126 has Karaoke media files stored thereon and is accessible by a playback portion of the compact disc player 124 for outputting respective contents of the Karaoke media files stored on the compact discs 126. A third one of the digital media sources 106 is a hard drive 128 having digital memory 130 with Karaoke media files stored thereon. Each one of the Karaoke media files stored on the digital memory 130 of the hard drive 128 is accessible by a playback portion of the hard drive 128 or, optionally, other component of the Karaoke media system 100 for outputting respective contents of the Karaoke media files stored on the digital memory 130 of the hard drive 128. A fourth one of the digital media sources 106 is a patron-accessible Universal Serial Bus (USB) interface 132. The USB interface 132 is patron-accessible (i.e., accessible by a Karaoke performer) for enabling one or more Karaoke media files stored on a memory device of a Karaoke performer (i.e., a portable MP3 player, portable hard drive, a laptop computer, a USB drive, etc) to be accessed and outputted. For example, a playback portion of the MP3 player 120 performs accessing and playback of the one or more Karaoke media files stored on the memory device of the Karaoke performer. A fifth one of the digital media sources 106 is a patron-accessible CD drive 134. The CD drive 134 is user accessible for enabling one or more Karaoke media files stored on a CD disc of a Karaoke performer to be accessed and outputted by a playback portion of the CD drive 134. A sixth one of the digital media sources 106 is a network interface 136. The network interface 136 enables Karaoke media files stored on remote computer system (e.g., that of a company providing downloadable Karaoke media files) to be downloaded to memory of the Karaoke media system 100 (e.g., the memory 112 of the session management unit, the memory 122 of the MP3 player 120 and/or the memory 130 of the hard drive 128). Accordingly, the various digital media sources 106 each enable accessing and, optionally, storage of Karaoke media files.

The input-output components 108 enable audio, video and textual content of a Karaoke session to be inputted and outputted. A first one of the input-output components 108 includes a microphone interface 138 and a microphone 140 connected to the microphone interface 138 for enabling a voice signal from the microphone 140 to be received and processed for being outputted. It is disclosed herein that the microphone interface 138 may include a plurality of microphone ports for enabling a plurality of microphones to be connected to the microphone interface. Such plurality of microphones enables more than one microphone to be used during a Karaoke session (i.e., different performers or groups of performers each using a different microphone while performing to a song). A second one of the input-output components 108 includes an audio output interface 142 and a speaker 144 connected to the audio output interface 142 for enabling audio content of a Karaoke session (e.g., music and voice signals) to be outputted from the speaker 144. It is disclosed herein that the audio output interface 142 may include a plurality of audio output ports for enabling a plurality of audio output devices (e.g., speakers) to be connected to the audio output interface 142. A third one of the input-output components 108 includes a video output interface 146 and a video display 148 connected to the video output interface 146 for enabling video content of a Karaoke session (e.g., lyrics) to be outputted from the video display 148. It is disclosed herein that the video output interface 148 may include a plurality of audio output ports for enabling a plurality of video output devices (e.g., video monitors) to be connected to the video output interface 146. A fourth one of the input-output components 108 includes a printer interface 150 and a document printer 152 connected to the printer interface 150 for enabling Karaoke session information (e.g., Karaoke media choice directory, session performing instructions, lyrics, etc) to be outputted from the Karaoke media system 100 in printed form. It is disclosed herein that the microphone 140, speaker 144, video display 148 and/or document printer 152 may be omitted as components of the Karaoke media system 100 and may be standalone components or components of remote apparatuses or systems.

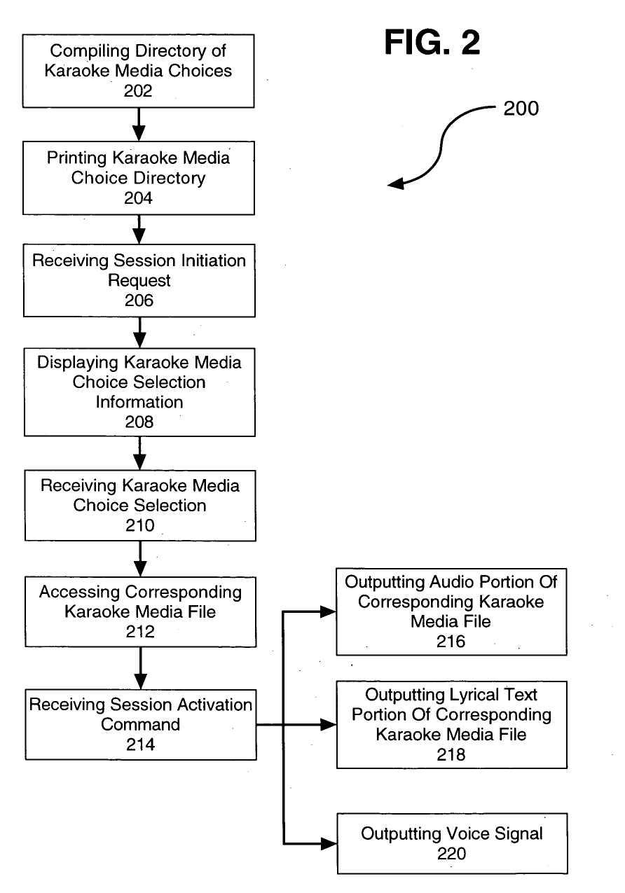

Referring now to FIG. 2, a method 200 is disclosed for facilitating Karaoke session functionality in accordance with the present invention. In one embodiment, the method 200 is carried out through processing of the system operating instructions 114 of the Karaoke media system 100 discussed in reference to FIG. 1. Such processing entails the data processing device 110 interpreting the 114 for causing interoperability of the user interface 104, digital media sources 106 and input-output components 108, thereby enabling Karaoke session functionality in accordance with the present invention to be provided by the Karaoke media system 100.

The method 100 begins with an operation 202 for compiling a directory of Karaoke media choices, which is followed by an operation 204 for printing the Karaoke media choice directory. Karaoke performers use the Karaoke media choice directory for determining which one of a plurality of system-managed Karaoke media files they will be performing. The system-managed Karaoke media files are those Karaoke media files that are resident on storage of a Karaoke media system carrying out the method and/or those Karaoke media files that are predictably accessible by the Karaoke media system. Karaoke media files residing on compact discs of the Karaoke media system, residing on digital memory of the Karaoke media system and downloadable from a dedicated download source (e.g., a company providing on-demand download service of Karaoke media files) are examples of Karaoke media files that are predictably accessible by the Karaoke media system.

After a Karaoke performer has determine a Karaoke media choice they would like to perform, they interact with the user interface of the Karaoke media system for causing an operation 206 being performed for receiving a session initiation request. In one embodiment, receiving the session initiation request includes receiving payment for the session. In another embodiment, receiving the session initiation request includes receiving a command for displaying Karaoke media choice selection information (e.g., in response to pressing a dedicated button or specific portion of a touch screen). In response to receiving the session initiation request, an operation 208 is performed for displaying Karaoke media choice selection information. Examples of the Karaoke media choice selection information includes, but is not limited to, titles of songs, musical genre names, names of musical artists, time period for songs, and directions for enabling patron provided Karaoke media files to be downloaded.

After displaying the Karaoke media choice selection information, an operation 210 is performed for receiving a Karaoke media choice selection to which the Karaoke performer chooses to perform. The Karaoke media choice selection corresponds to a Karaoke media file accessible by the Karaoke media system through one of its digital media sources. In response to receiving the Karaoke media choice selection, an operation 212 is performed for accessing the Karaoke media file corresponding to the Karaoke media choice selection. After accessing the Karaoke media file corresponding to the Karaoke media choice selection, an operation 214 is performed for receiving a session activation command. For example, within an allotted time period from when the Karaoke media file corresponding to the Karaoke media choice selection is accessed, the Karaoke performer presses a session start button of the Karaoke media system, which results in a session activation command to be issued. In response to the session activation command being received, an operation 216 is performed for audibly outputting an audio portion of the Karaoke media file, an operation 218 is performed for video outputting a lyrical text portion of the Karaoke media file in synchronous relationship to the audio portion of the Karaoke media file and an operation 220 is performed for outputting a voice signal received at a microphone. It is disclosed herein that video outputting of the lyrical text portion of the Karaoke media file may be omitted and/or the lyrical text portion of the Karaoke media file may be outputted in printed form prior to the operation for receiving the session activation command.

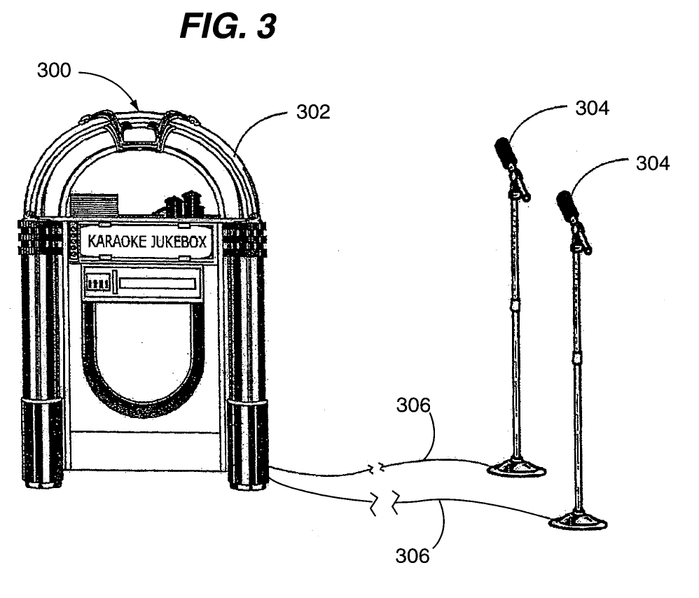

FIG. 3 shows an embodiment of a Karaoke machine in accordance with the present invention, which is referred to herein as the Karaoke machine 300. It is disclosed herein that the Karaoke machine 300 may have an aesthetic design similar to that of any conventional Jukebox. Various and diverse designs for conventional Jukeboxes are well known.

The Karaoke machine 300 is configured for providing Karaoke functionality in accordance with the present invention. In one embodiment, the Karaoke machine 300 comprises the Karaoke media system 100 disclosed and discussed above. In another embodiment, the Karaoke machine 300 includes all of the elements of the Karaoke media system 100 disclosed and discussed above, with the exception of fewer than all of the digital media sources 106 and omission of the microphone 140, the speaker 144, the video display 148 and the document printer 152. In such an embodiment, the microphone 140, the speaker 144, the video display 148 and/or the document printer 152 are standalone units or units of standalone apparatuses and are each interconnected to the Karaoke machine 300 through a respective interface.

The Karaoke machine 300 includes a body 302 having an interior space therein and a plurality of exterior surfaces. The session management unit 102, the user interface 104 and at least one of the digital media sources 106 are mounted within or on the body 302. Patron-accessible interfaces are exposed at a respective one of the exterior surfaces of the body 302. Patron accessible portions of the user interface 104 are exposed at a respective one of the exterior surfaces of the body 302. A plurality of standalone microphones 304 are connected to a microphone interface of the Karaoke machine 300 through respective cable 306 or, optionally, wirelessly through the audio input interface.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A Karaoke machine, comprising:
a plurality of digital media sources, wherein said digital media sources include a hard drive having Karaoke media files stored thereon, a MP3 player having memory with Karaoke media files stored thereon, a compact disc player including a collection of compacts discs each having Karaoke media files stored thereon, a patron-accessible compact disc drive and a patron-accessible Universal Serial Bus Interface;
a user interface enabling a user to select a Karaoke media file corresponding to a respective one of said Karaoke media files accessible by one of said digital media sources;
a microphone input interface enabling a voice signal to be received from a microphone; and
a machine session management unit coupled to the digital media sources, the user interface and the microphone input interface, wherein the machine session management unit facilitates receiving said selected Karaoke media file, accessing the respective one of said the Karaoke media files, outputting a musical audio portion of the respective one of said Karaoke media files and outputting the voice signal in conjunction with said outputting the musical audio portion of the respective one of said Karaoke media file.

2. The Karaoke machine of claim 1 wherein:
the machine session management unit includes memory and at least one data processing module coupled to said memory;
said memory having system operating instructions accessible therefrom by said at least one data processing module,
said at least one data processing device configured for accessing and processing of said instructions;
processing of said instructions facilitates:
the respective one of said Karaoke media files to be accessed from the digital media source; and
said outputting of the voice signal and the musical audio portion of the respective one of said Karaoke media files.

3. The Karaoke machine of claim 2 wherein:
the user interface includes a touch screen display; and
processing of said instructions facilitates available Karaoke media files being displayed on the touch screen display and a desired one of said available Karaoke media files being selected by touching the touch screen display.

4. The Karaoke machine of claim 3, further comprising:
a video display enabling a lyrical text portion of the respective one of said Karaoke media files to be outputted thereon;
a speaker enabling a musical audio portion of the respective one of said Karaoke media files to be outputted therethrough; and
a document printer enabling Karaoke session information to be outputted therefrom in printed form.

5. The Karaoke machine of claim 3, further comprising:
a video output interface for enabling a lyrical text portion of the respective one of said Karaoke media files to be outputted to a remote video display apparatus;
an audio output interface for enabling a musical audio portion of the respective one of said Karaoke media files to be outputted to a remote audio output apparatus; and
a document printer interface for enabling Karaoke session information to be outputted in printed form.

6. The Karaoke machine of claim 1, further comprising:
a video output interface for enabling a lyrical text portion of the respective one of said Karaoke media files to be outputted to a remote video display apparatus;
an audio output interface for enabling a musical audio portion of the respective one of said Karaoke media files to be outputted to a remote audio output apparatus; and
a document printer interface for enabling Karaoke session information to be outputted in printed form.

7. The Karaoke machine of claim 1, further comprising:
a video display enabling a lyrical text portion of the respective one of said Karaoke media files to be outputted thereon;
a speaker enabling a musical audio portion of the respective one of said Karaoke media files to be outputted therethrough; and
a document printer enabling Karaoke session information to be outputted therefrom in printed form.

8. A Karaoke media system, comprising:
a first digital media source enabling Karaoke media files to be accessed therefrom;
a microphone input interface enabling a voice signal to be received from a microphone;
a video output interface enabling a lyrical text portion of said Karaoke media files to be outputted to a remote video display apparatus;
an audio output interface enabling a musical audio portion of said Karaoke media files to be outputted to a remote audio output apparatus;
a document printer interface enabling Karaoke session information to be outputted in printed form;
memory having system operating instructions accessible therefrom,
at least one data processing device coupled to said memory for enabling said system operating instructions to be accessed and processed by said at least one data processing device, wherein processing of said instructions facilitates:
said Karaoke media files being accessed from the first digital media source;
the voice signal being received through the microphone input interface;
the lyrical text portion of said Karaoke media files being outputted to the remote audio output apparatus through the video output interface;
the musical audio portion of said Karaoke media files being outputted to the remote video display unit through the audio output interface; and
said Karaoke session information being outputted through the document printer interface to a printing device.

9. The Karaoke media system of claim 8 wherein the first digital media source is one of a hard drive having Karaoke media files stored thereon, a MP3 player having memory with Karaoke media files stored thereon and a compact disc player including a collection of compacts discs each having Karaoke media files stored thereon.

10. The Karaoke media system of claim 9, further comprising:
a second digital media source enabling Karaoke media files to be accessed therefrom, wherein the second digital media source includes one of a patron-accessible compact disc drive and a patron-accessible Universal Serial Bus Interface.

11. The Karaoke media system of claim 8, further comprising:
a user interface enabling a user to select a Karaoke media file corresponding to a Karaoke media file accessible by the first digital media source.

12. The Karaoke media system of claim 11 wherein:
the user interface includes a touch screen display; and
processing of the system operating instructions facilitates available Karaoke media files being displayed on the touch screen display and a desired one of said available Karaoke media files being selected by touching the touch screen display.

13. The Karaoke media system of claim 8, further comprising:
a video display connected to the video output interface for enabling the lyrical text portion of said Karaoke media files to be outputted thereon;
a speaker connected to the audio output interface for enabling the musical audio portion of said Karaoke media files to be outputted therethrough; and
a document printer connected to the printer interface for enabling said Karaoke session information to be outputted therefrom in printed form.

14. A method for facilitating a Karaoke session, comprising:
receiving a request for initiating a Karaoke session, wherein said request is received by a data processing device of a Karaoke media system;
displaying selection information for Karaoke media files accessible from a digital media source of the Karaoke media system;
receiving a Karaoke media file selection corresponding to one of said available Karaoke media files, wherein the Karaoke media file selection is received by the data processing module of the Karaoke media system;
accessing a Karaoke media file corresponding to the Karaoke media file selection, wherein said accessing is performed by the digital media source of the Karaoke media system;
outputting an audio portion of the Karaoke media file, wherein said outputting of the audio portion is facilitated through a speaker output interface of the Karaoke media system; and
outputting a voice signal received at a microphone input interface of the Karaoke media system in conjunction with outputting the audio portion of the Karaoke media file, wherein said outputting the voice signal is facilitated through an audio output interface of the Karaoke media system.

15. The method of claim 14, further comprising:
printing Karaoke session information corresponding to said available Karaoke media files, wherein said Karaoke session information corresponding to said available Karaoke media files includes a Karaoke media file directory listing all of said available Karaoke media files.

16. The method of claim 15, further comprising:
outputting a lyrical text portion of the Karaoke media file synchronously with said outputting of the audio portion of the Karaoke media file, wherein said outputting of the lyrical text portion is performed through a video output interface of the Karaoke media system.

17. The method of claim 14, further comprising:
downloading at least a portion of said Karaoke media files to the digital media source.

18. The method of claim 17 wherein:
the digital media source includes non-volatile memory; and
said downloading is performed over a network interface of the Karaoke media system.

19. The method of claim 18, further comprising:
outputting a lyrical text portion of the Karaoke media file synchronously with said outputting of the audio portion of the Karaoke media file, wherein said outputting of the lyrical text portion is performed through a video output interface of the Karaoke media system.

20. The method of claim 14, further comprising:
outputting a lyrical text portion of the Karaoke media file synchronously with said outputting of the audio portion of the Karaoke media file, wherein said outputting of the lyrical text portion is performed through a video output interface of the Karaoke media system.
